(19) United States
(12) Patent Application Publication
(10) Pub. No.: US 2018/0321369 A1
(43) Pub. Date: Nov. 8, 2018

(54) INTEGRATED ELECTROMAGNETIC SEEKER

(71) Applicant: ISRAEL AEROSPACE INDUSTRIES LTD., LOD (IL)

(72) Inventor: Moshik Cohen, Petah Tikva (IL)

(21) Appl. No.: 15/774,871

(22) PCT Filed: Nov. 10, 2016
(86) PCT No.: PCT/IL2016/051213

§ 371 Date: May 9, 2018

(30) Foreign Application Priority Data
Nov. 12, 2015 (IL) 242588

(51) Int. Cl. G01S 13/44; G01S 7/03; G01S 3/783; F41G 7/22

(52) U.S. Cl. CPC G01S 13/44; F41G 7/2293; G01S 3/783; G01S 7/03

(57) ABSTRACT

The presently disclosed subject matter includes an electromagnetic seeker comprising: an antenna having multiple radiating elements; the antenna is divided into a plurality of sections, each section comprising a group of radiating elements and is directly connected to a respective single power stage configured to provide power to the radiating elements; each section and a respective single power stage are configured to provide a coherent combination of signals transmitted by different antenna sections over the air to thereby enable combination of power from all antenna sections over the air.

### FIELD OF THE INVENTION

This invention relates to electromagnetic seekers

### BACKGROUND

An electromagnetic seeker includes a transmitter assembly for transmitting pulsed radiations and a receiver assembly for receiving reflections that surpasses an adjustable detection threshold. The electromagnetic seeker also includes a target reflection detection module for detecting a desired target as well as estimators for estimating various target parameters and trackers for implementing target tracking.

### GENERAL DESCRIPTION

The presently disclosed subject matter includes a new electromagnetic seeker mountable on an airborne platform such as a missile or aircraft and capable of performing different operations such as: searching for a target; detecting the target; tracking the target; and homing on the target.

In general the transmitter assembly of an electromagnetic seeker transmits an electromagnetic signal (such as a laser signal) towards a search volume (area desired to be searched for targets). Signal portions reflected from a target are received by the receiver assembly and processed by a signal processing unit in the seeker. The ability of the seeker to detect signal portions reflected from a target depends, inter alia, on the signal to noise ratio (SNR) of the signal portions reflected from the target which are received by the seeker.

The SNR depends on various parameters some of which are related to the architecture and operation of the seeker. One parameter is the power of the signal transmitted by the transmitter assembly. Another parameter is the attenuation level of the signals which are transmitted by the transmitter assembly and the attenuation level of the signals received by the receiver assembly.

Attenuation of transmitted signals occurs for example, during power combination from different power stages and during passage of the signals through cables and connectors directing the signal towards the antenna for transmission. Attenuation of received signals occurs during passage of the received signal through various seeker components (e.g. antenna, filter, isolator, limiter, cables, comparators, etc.) located between the seeker head and the seeker low noise amplifier.

Thus, in order to improve the efficiency of the seeker it is desirable to reduce the signal attenuation (radio frequency (RF) losses) caused by the seeker components.

The presently disclosed subject matter includes an electromagnetic seeker with a new architecture which enables to reduce the RF losses and thereby improve the SNR.

According to some examples of the presently disclosed subject matter, there is provided an electromagnetic seeker comprising:
an antenna having multiple radiating elements; the antenna is divided into a plurality of sections each section comprising a group of radiating elements and is directly connected to a respective single power stage configured to provide power to the radiating elements; each section and a respective single power stage are configured to provide coherent combination of signals transmitted by different antenna sections over the air to thereby enable combination of power from all antenna sections over the air.

The seeker according to the above aspect of the presently disclosed subject matter can optionally comprise one or more of the features below in any technically possible combination or permutation:

The seeker further comprises a respective receiving channel directly connected to each antenna section; the receiving channel is connected further to a processing unit comprising a digital comparator module configured to digitally provide mono-pulse signals;

Wherein the receiving channel is configured as a single sub-assembly printed on a circuit board as single integrated unit;

The seeker is mounted on a single printed circuit board;

The seeker according to claim 1 wherein each one of the single power stages is printed on the opposite side of the antenna printed circuit board;

The seeker is mounted entirely on a gimbal assembly; and

The seeker according to any one of the preceding claims is a laser seeker.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a functional block diagram schematically illustrating an example of a laser system, in accordance with the presently disclosed subject matter;

FIG. 2 is a flowchart illustrating an example of a sequence of operation performed during interception of a single target, in accordance with the presently disclosed subject matter; and

FIG. 3 shows a graph demonstrating the SNR as a function of the range between the seeker and target obtained with by a seeker configured according to the architecture disclosed herein.

### DETAILED DESCRIPTION

As used herein, the phrase “for example,” “such as” and variants thereof describing exemplary implementations of the present invention are exemplary in nature and not limiting.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. While the invention has been shown and described with respect to particular embodiments, it is not thus limited. Numerous modifications, changes and improvements within the scope of the invention will now occur to the reader.

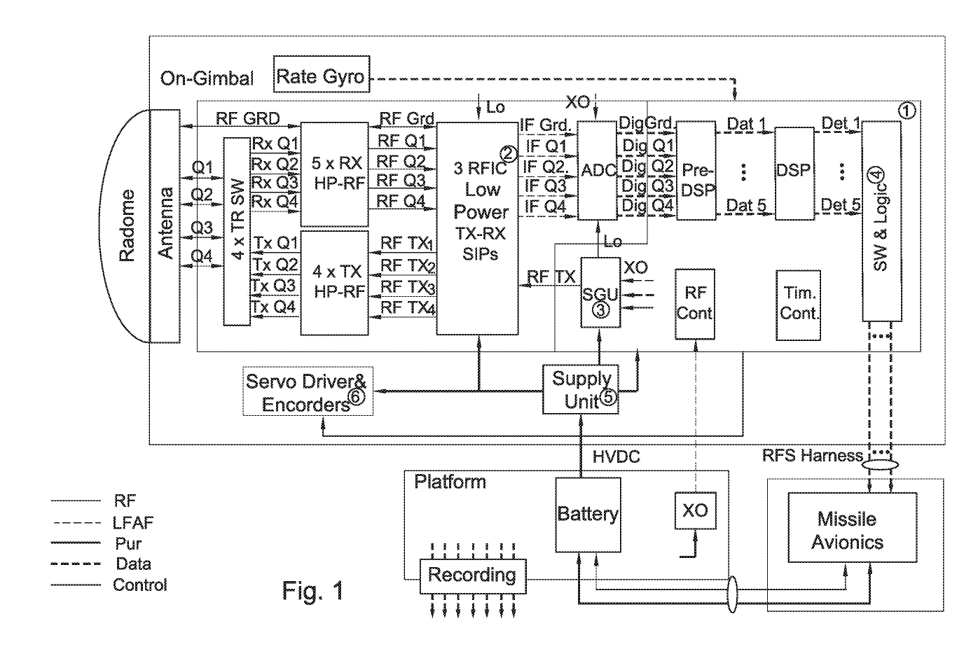

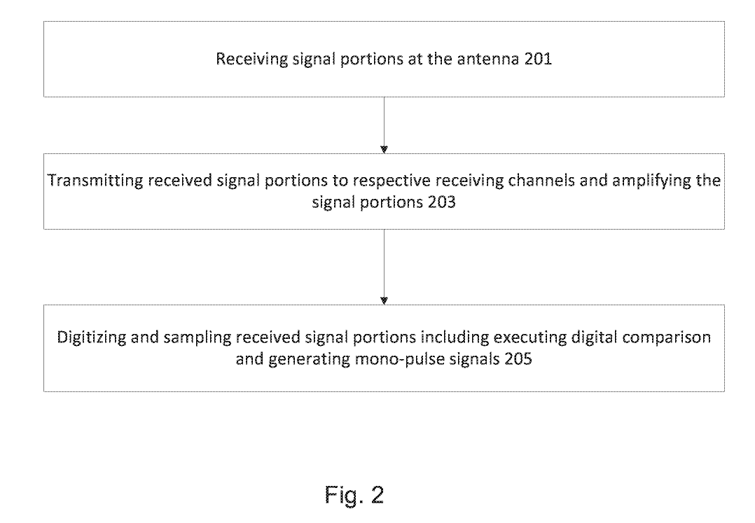

In embodiments of the invention, fewer, more and/or different stages than those shown in FIG. 2. may be executed. In embodiments of the invention multiple stages illustrated in FIG. 2. may be executed simultaneously. FIG. 1 illustrates a schematic of the system architecture in accordance with embodiments of the invention. Module/Units in FIG. 1 can be made up of any combination of software and hardware and\or firmware that performs the functions as defined and explained herein. Modules/Units in FIG. 1 may be centralized in one location or dispersed over more than one location. In other embodiments of the, the system may comprise fewer, more and or different modules than those shown in FIG. 1.

Bearing the above in mind, attention is now drawn to FIG. 1 showing a functional block diagram schematically illustrating an example of an electromagnetic seeker 100, in accordance with the presently disclosed subject matter.

Transmitter Assembly:

Previously known architectures of transmitter assemblies in electromagnetic seekers include a single transmitter unit comprising numerous power stages (e.g. power transistors) which are combined to create a single transmission signal. This signal is routed using RF connectors and cables to the antenna for over the air transmission towards the search volume. Thus, according to this approach multiple power stages are physically connected to increase the power output which is delivered to the antenna.

The inter-connections between the numerous power stages in the transmitter unit involve high RF losses which is a first source of signal attenuation. The cables and connectors leading the signal to the transmitting antenna from the transmitter unit also involve considerable RF loss, which is a second source of signal attenuation.

Receiver Assembly:

Previously known architectures of receiver assemblies in electromagnetic seekers include RF comparator, RF switches and cables which are connected between the antenna and a receiving channel. The comparator, switches and cables are a third source of attenuation occurring after signal reception. In addition, the receiving channel comprises a plurality of sub-assemblies which are inter-connected by cables and connectors. These cables and connector provide a fourth source of attenuation.

FIG. 1 shows a functional block diagram of a new seeker architecture disclosed herein. The disclosed architecture helps to reduce the RF signal loss that is found in the prior art seekers. The proposed architecture addresses all four RF loss sources which were described above.

New Transmitter Assembly:

A seeker antenna comprises multiple (e.g. 100 or more) radiating elements which are normally divided into a number of sections, typically 4 quarters. According to the presently disclosed subject matter, a single power stage is directly connected to a group of antenna radiating elements. For example, in an antenna divided into 4 sections, in this case quarters, the radiating elements in each quarter are directly connected to a single power stage. By connecting the power stage directly to the antenna and avoiding the inter-connection between different power stages, the first source of signal attenuation is eliminated or at least considerably reduced.

Additionally, the combination of the signals emitted by each power stage is performed by coherent combination over the air (not by cable), which reduces RF loss that normally occurs when physical connections are used. The power stage and the antenna are specifically configured to ensure that the transmitted signals from all part of the antenna are coherently combined in the air.

Furthermore, the single power stage is directly connected to each group of radiating elements without using any cables and connectors. For example, the power stages can be printed on the opposite side of the antenna printed circuit board (PCB). This direct connection provides the elimination (or at least reduction) of the second source of signal attenuation.

New Receiver Assembly:

According to the disclosed electromagnetic seeker architecture, the RF comparator is removed and a respective receiving channel is directly connected to a group of the antenna radiating elements (antenna section). The receiving channel can include for example: low noise amplifiers, RF band pass filter, RF frequency translator. The receiving channel is connected at the other end to a processing unit.

Notably, by connecting the receiving channel directly to the antenna, the switches which are connected to the comparator in prior art receiving assemblies are also removed. This allows to overcome (or at least reduce) the third source of attenuation occurring after signal reception mentioned above which is caused by the RF comparator, switches and connectors.

The functionalities of the comparator are digitally implemented by the processing unit (1) (denoted by way of example in FIG. 1 as Ultrascale FPGA by Xilinx®) which includes an embedded ARM CPU. The processing unit comprises software & logic (4). The processing unit comprises a respective module (digital comparator module) configured to perform the relevant operations of the comparators. The digital comparator module is configured, inter alia, to generate and provide the mono-pulse signals (Σ, Δ_{az}, Δₑₗ).

Additionally, according to some examples the receiving channel is designed and implemented as a single sub-assembly printed as single integrated unit. For example, this can be accomplished by using CMOS 65 nm technology. This is different than the common approach which divides the receiving channel into a number of sub-assemblies each on a separate printed board and uses connectors and cables in order to connect between the different sub-assemblies. This allows overcoming (or at least reducing) the fourth source of attenuation as mentioned above.

As mentioned above, prior art transmitter assemblies include a transmitter unit which comprises multiple power stages each providing a respective amount of power. The number of power stages which are used in a transmitter unit is adapted to provide the required total power for obtaining desired SNR values. Because of power attenuation resulting from the design, cables and connections in the transmitter unit, the actual power which is provided by the combination of power stages is smaller than the mathematical combination of the power values of all the power stages added together. Thus, more power stages are needed in order to obtain the required total power for transmission.

According to the presently disclosed subject matter, since the power stages are directly connected to the antenna elements, and the use of cables and connectors is considerably reduces (if not eliminated), the same power can be generated using a considerably smaller number of power stages than before. Furthermore, the power generated in a seeker and the respective power of the generated signal can exceed the power of the signal which is generated according to the old technology mentioned above while the dimensions of the seeker can be reduced. This allows increasing the generated power and obtaining a signal transmission with greater power. It also allows reducing manufacturing costs and obtaining a seeker with a more compact design and a smaller weight.

According to the one example, the entire seeker can be mounted on a single printed circuit board. This can be accomplished due to the fact that the architecture includes a smaller number of discrete components and due to the direct connection between them.

As illustrated in FIG. 1 the entire seeker can be mounted on the gimbal assembly.

FIG. 1 shows an example of 4 quarter antenna. Each quarter (Q1-Q4) is connected to single power stage (4*Tx HP RF) for transmission. Notably, the power stage is directly connected to a respective antenna quarter.

FIG. 1 further shows each quarter is connected to single receiving channel (5*Rx HP RF (5^{th} is for the guard channel) for reception. Notably, the RF comparator is not present. As exemplified in FIG. 1 the entire seeker is mounted on a single PCB (on the Gimbal) and accordingly the use of cables and connectors is almost completely avoided.

In addition to improved SNR and smaller dimensions (allowing mounting the entire seeker on the Gimbal for example) the proposed architecture can also help in reducing the manufacturing complexity of the seeker as well as the price tag.

FIG. 1 also shows a radio frequency intergraded circuit (2), signal generation unit SGU (3) operative connected to the RFIC and analog to digital converter (ADC). Also shown is pre-DSP (digital signal processing; implemented for example with firmware). Post-DSP can be implemented on integrated ARM. Power supply unit (5) (e.g. battery) can supply high voltage direct current (HVDC). Servo drivers and encoders (6) provide on-gimbal angle measurements. Missile avionics include control over missile flight e.g. based on received signal reflections from target.

FIG. 2 is a flowchart illustrating an example of a sequence of operation performed during interception of a single target, in accordance with the presently disclosed subject matter. Operations described with reference to FIG. 2 can be executed for example, by electromagnetic seeker described above with reference to FIG. 1.

At block 201 signal portions are received at the antenna. At block 203, the signal portions are transmitted to a respective receiving channel where they are amplified. The signal portions at each receiving channel is sampled and digitally processed (block 205). The digital processing includes the digital comparator functionalities including the generation of mono-pulse signals.

As mentioned above, according to the suggested approach comparator is implemented digitally and the generation of the mono-pulse signals is executed after the received signal portions have already been amplified.

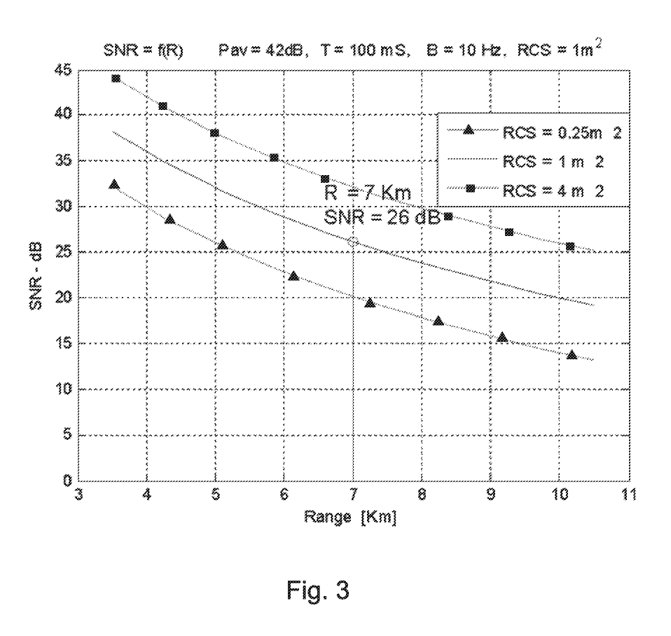

FIG. 3 is graph demonstrating the SNR as a function of the range between the seeker and target, according to an example of the presently disclosed subject matter. The graphs shows the result of the operation of a seeker configured according to the principles disclosed herein. The results of 3 different aircraft target types including: a small aircraft (RCS˜0.25 m², e.g. unmanned aerial vehicle), medium size aircraft (RCS˜1 m², e.g. F16 eagle), and a large size aircraft (RCS=4 m², e.g. Boeing 747). The line at the bottom of the graph (ranging from about 32.5 db to about 13 db) shows the result of the small aircraft, the middle line in the graph shows the result of the medium aircraft and the top line shows the result of the large size aircraft. As can be seen in the graph, a detection range (SNR>10 dB) larger than 10 km. is achieved for all three targets.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as basis for designing other structures, methods, and systems for carrying out the several purposes of the presently disclosed subject matter.

1. An electromagnetic seeker, comprising:
an antenna having multiple radiating elements;
wherein the antenna is divided into a plurality of sections, each of the plurality of sections comprising a group of the multiple radiating elements and is directly connected to a respective single power stage configured to provide power to the group of the multiple radiating elements;
wherein each of the plurality of sections and the respective single power stage are configured to provide coherent combination of signals transmitted by different antenna sections of the plurality of sections over air to thereby enable combination of power from all of the plurality of sections over the air.

2. The electromagnetic seeker of claim 1, further comprising a respective receiving channel directly connected to each of the plurality of sections; the receiving channel is further connected to a processing unit comprising a digital comparator module configured to digitally provide mono-pulse signals.

3. The electromagnetic seeker according to claim 2 wherein the receiving channel is configured as a single sub-assembly printed on a circuit board as a single integrated unit

4. The electromagnetic seeker according to claim 1 mounted on a single printed circuit board.

5. The electromagnetic seeker according to claim 1 wherein each one of the respective single power stages is printed on an opposite side of an antenna printed circuit board.

6. The electromagnetic seeker according to claim 1 is mounted entirely on a gimbal assembly.

7. The electromagnetic seeker according to claim 1 is a laser seeker.
